(19) United States
(12) Patent Application Publication
(10) Pub. No.: US 2026/0043998 A1
(43) Pub. Date: Feb. 12, 2026

(54) ULTRASONIC CLEANING DEVICE CONTROLLER AND METHOD WITH DRIVE FREQUENCY ADAPTATION WHILE DRIVING

(71) Applicant: SEMICONDUCTOR COMPONENTS INDUSTRIES, LLC, Scottsdale, AZ (US)

(72) Inventors: Marek HUSTAVA, Bratislava (SK); Pavel KOSTELNIK, Bordovice (SK); Michal NAVRATIL, Pustimer (CZ)

(73) Assignee: SEMICONDUCTOR COMPONENTS INDUSTRIES, LLC, Scottsdale, AZ (US)

(21) Appl. No.: 19/048,128

(22) Filed: Feb. 7, 2025

Related U.S. Application Data
(60) Provisional application No. 63/680,474, filed on Aug. 7, 2024.

(51) Int. Cl. G02B 27/00; B06B 1/02; B06B 1/06; B08B 3/12

(52) U.S. Cl. CPC G02B 27/0006; B06B 1/0215; B06B 1/0651; B08B 3/12; B06B 2201/55; B06B 2201/70

(57) ABSTRACT

Sensors may incorporate ultrasonic cleaning device controllers and methods to keep their exposed surfaces free from water, ice, and other adherent substances. One illustrative controller includes a driver configured to drive a transducer with a periodic waveform having voltage pulses and high impedance intervals repeating at a drive frequency. The controller may also include a receiver configured to measure a high impedance voltage of the transducer during the high impedance intervals. The controller may further include control logic configured to adjust the drive frequency using the high impedance voltage to track a resonance frequency of the transducer. Some implementations may use diagnostic bursts with lower voltage pulse magnitudes for tracking and cleaning bursts with higher voltage pulse magnitudes for cleaning. Duty cycle fading may be employed to prevent voltage overshoots after each burst.

### CROSS-REFERENCE TO RELATED APPLICATIONS

The present application claims benefit of Provisional U.S. Application 63/680,474, titled “Ultrasonic Lens Cleaning Device” and filed 2024 Aug. 7 naming inventors Marek Hustava, Pavel Kostelnik, and Michal Navratil. The foregoing application is hereby incorporated herein by reference in its entirety.

### TECHNICAL FIELD

The present disclosure relates generally to sensor cleaning systems for vehicles. More particularly, it relates to systems and methods for controlling ultrasonic cleaning devices to remove contaminants from camera lenses and other sensor surfaces in automotive applications.

### BACKGROUND

Modern vehicles are equipped with an impressive number and variety of sensors to enable advanced driver assistance systems (ADAS) and autonomous driving capabilities. Cameras, radar, and lidar sensors are examples of such sensors that may be useful for providing the environmental awareness needed by such systems. However, the performance of these sensors can be significantly degraded when their lenses or covers become obstructed by water droplets, ice, snow, mud, or other contaminants. The reliability and safety of ADAS and autonomous driving systems is dependent on having unobstructed sensors.

Various sensor cleaning techniques have been developed, including mechanical wipers, high-pressure water/air/mist jets, and heating elements. However, these approaches often have drawbacks such as added weight, high power consumption, or the need for additional components that may interfere with sensor operation. Ultrasonic cleaning devices (USCDs) have emerged as a promising solution, offering efficient cleaning with minimal added components. However, existing USCD control systems may lack optimal efficiency, diagnostic capabilities, or the ability to adapt to different environmental conditions.

### SUMMARY

Accordingly, there are disclosed herein illustrative controllers, methods, and sensors for cleaning surfaces using ultrasonic vibrations. One illustrative controller includes a driver configured to drive a cleaning transducer with a periodic waveform having voltage pulses and high impedance intervals repeating at a drive frequency. The controller may also include a receiver configured to measure a high impedance voltage of the cleaning transducer during the high impedance intervals. The controller may further include control logic configured to adjust the drive frequency using the high impedance voltage to track a resonance frequency of the cleaning transducer.

Another illustrative controller includes a driver configured to drive a cleaning transducer with a periodic waveform having voltage pulses. The illustrative controller further includes control logic that performs a diagnostic operation using the periodic waveform to determine a resonance frequency of the cleaning transducer and performs a cleaning operation using the periodic waveform with a voltage pulse magnitude that is larger than a voltage pulse magnitude used for the diagnostic operation.

Yet another illustrative controller includes a driver configured to drive a cleaning transducer with a periodic waveform having voltage pulses and high impedance intervals at a duty cycle having an initial value. The illustrative controller further includes control logic configured to reduce the duty cycle of the periodic waveform to a pre-termination value before terminating the periodic waveform with a high impedance state.

The illustrative controllers may perform corresponding methods and may be incorporated into illustrative sensors having a lens surface exposed to adherent substances and a cleaning transducer configured to impart ultrasonic vibrations to the lens surface.

Each of the foregoing examples can be employed individually or in conjunction and may include one or more of the following features in any suitable combination: 1. The voltage pulses may include zero voltage pulses and nonzero voltage pulses. 2. The controller may be configured to measure a low impedance voltage of the cleaning transducer during the zero voltage pulses. 3. The controller may determine based on a sign of a difference voltage between the high impedance voltage and the low impedance voltage whether the resonance frequency is greater or less than the drive frequency. 4. The controller may be configured to adjust the drive frequency with a step size of no more than 20 Hz. 5. The resonance frequency may be a center frequency of a high-Q peak that is dependent on adherent substance loading of a lens surface vibrationally coupled to the cleaning transducer. 6. The controller may be configured to find the resonance frequency on start up or reset by scanning a predetermined frequency range to identify a resonance peak and performing a cleaning operation to fine tune the drive frequency. 7. The controller may be configured to perform periodic diagnostic operations to monitor the resonance frequency. 8. The controller may be configured to perform a de-icing operation if the resonance frequency exceeds a predetermined threshold. 9. The controller may be configured to perform a cleaning operation if the resonance frequency changes by more than a predetermined amount between diagnostic operations. 10. The diagnostic operations may have nonzero voltage pulses of a reduced magnitude relative to a magnitude of nonzero voltage pulses for a cleaning operation. 11. The controller may include a variable voltage converter configured to provide a supply voltage for driving the cleaning transducer. 12. The control logic may be configured to temporarily raise a setpoint for the variable voltage converter while performing a cleaning operation. 13. The de-icing pulse magnitude being larger than the diagnostic pulse magnitude. 14. The control logic may be configured to temporarily raise a setpoint for the variable voltage converter while performing the de-icing operation.

### BRIEF DESCRIPTION OF THE DRAWINGS

FIG. 1A is a side view of an illustrative ultrasonic cleaning device (USCD)-equipped sensor.

FIG. 1B is a top view of the illustrative sensor.

FIG. 2 is a block diagram of an illustrative USCD-equipped sensor.

FIG. 3 is a graph showing displacement versus frequency for an illustrative USCD.

FIG. 4 is a graph showing impedance versus frequency for an illustrative USCD at different temperatures.

FIG. 5 is a graph showing impedance versus frequency for an illustrative USCD under different loading conditions.

FIG. 6 is a timing diagram for illustrative multi-state driver signals.

FIGS. 7A-7C are graphs showing different end-of-driving sequences.

FIG. 8 is a graph showing an illustrative autonomous operations sequence.

FIG. 9 is a flow diagram of an illustrative USCD control method.

### DETAILED DESCRIPTION

The drawings and following description do not limit the disclosure, but on the contrary, they provide the foundation for one of ordinary skill in the art to understand all modifications, equivalents, and alternatives falling within the scope of the claim language.

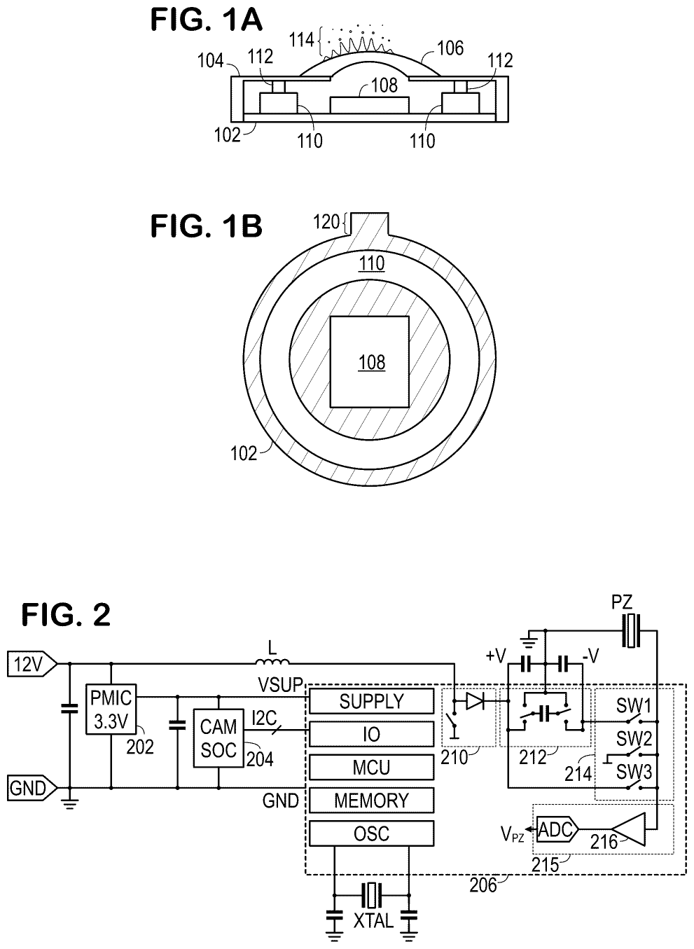

FIGS. 1A and 1B show side and top view cross-sections, respectively, of an illustrative camera with an integrated ultrasonic cleaning device (USCD). The camera includes a circuit substrate 102, which serves as a base for the electronics and other components. The circuit substrate 102 may be, e.g., a printed circuit board, an electronics package substrate, or a molded portion of the device casing to which the electronics are mounted. A case 104 encloses the internal components and provides structural support. The case 104 may include an aperture over which a lens 106 is mounted to focus an image on an image sensing portion of the device electronics. The upper surface of lens 106 may be exposed to the external environment, which may include adherent substances such as dust, dirt, water, ice, mud, snow, or the like, that can obstruct or distort image-forming light.

An integrated circuit 108 with an image sensor is mounted on the circuit substrate 102. The integrated circuit 108 may include a USCD controller and other control electronics for the camera. Adjacent to the integrated circuit 108 is one or more piezoelectric elements 110, which can generate vibrations for cleaning the lens 106.

The illustrated USCD includes one or more ribs or other buttressing elements 112 that mechanically couple the piezoelectric element(s) 110 to the supporting surface for the lens 106. This coupling communicates ultrasonic vibrations from the piezoelectric element 110 to the lens 106 and its supporting surface, providing mechanical energy to separate adherent substances from the surface of the lens 106. The mechanical energy of the vibrations may further operate to melt, disintegrate, and/or disperse the surface contaminants. A vibrating droplet 114 is shown on the surface of the lens 106, representing moisture or debris that the device is designed to remove. The desired vibration frequency may be in the range from 20 kHz to 1 MHz, with a drive signal power in the range from 1 W to 100 W, or in certain contemplated implementations, from 5 W to 20 W. The USCD components include the piezoelectric element 110, ribs 112, supporting surface, and lens 106, and the piezoelectric element 110 may be configured to have a characteristic resonance frequency suitable to the desired application of the USCD, may be designed to provide a broad frequency response range, or may be given supporting components that provide an adjustable resonance frequency or multiple usable resonance frequencies.

The arrangement of components allows for a compact design where the piezoelectric element 110 can effectively transmit vibrations to the lens 106 for cleaning purposes, while the integrated circuit 108 controls the operation of the device. In other cases, the piezoelectric element 110 may be positioned in different locations within the device, or multiple piezoelectric elements may be used, depending on the specific requirements of the application. In at least some embodiments, additional discrete components are provided on the circuit substrate 102 to support operation of the integrated circuit 108 and/or to interface with the piezoelectric element 110.

Referring to FIG. 1B, a top view of the circuit substrate 102 is illustrated. In some contemplated embodiments, the piezoelectric element 110 is in the form of a circular ring mounted on the circuit substrate 102. The piezoelectric element 110 may surround the integrated circuit 108.

In some cases, the circuit substrate 102 includes a tab 120 configured as an edge connector. The tab 120 may be printed with gold finger contacts and be configured to connect external wiring to the device electronics. This arrangement allows for easy connection and disconnection of the device from external systems, such as wiring to receive power and communicate with an external controller or host system. In other cases, the tab 120 may be replaced with other types of connectors or interfaces, depending on the specific requirements of the application.

FIG. 2 shows a block diagram of an illustrative USCD-equipped sensor. The illustrative sensor includes a power management IC (PMIC) 202 that receives a 12V input and provides regulated 3.3V supply voltage to the system components. A camera system-on-chip (CAM SOC) 204 performs the main sensor function, e.g., image sensing and processing, and may communicate with the USCD via an I2C interface. The USCD is preferably implemented as a single-chip solution, e.g., a transducer controller 206 with a piezoelectric element (PZ), a minimal number of discrete components such as capacitors, and an optional quartz crystal (XTAL) for timing control.

The illustrated transducer controller 206 integrates various integrated circuit modules including: a supply module for power distribution to the other controller components; an input-output (IO) module for receiving and providing digital signals via the circuit substrate 102; a microcontroller unit (MCU) for implementing USCD control logic, a memory module (including, e.g., RAM, ROM, EEPROM, OTP) for storing configuration parameter values, operational data, and firmware; an oscillator (OSC) module for clock generation with or without an external crystal, a DC-DC boost converter module 210 for generating selectable drive voltages; a voltage inverter 212; a four-state transducer driver 214; a programmable gain amplifier/attenuator (PGA) buffer 216; and an analog to digital converter (ADC).

Boost module 210 closes and opens a switch to alternately boost current flow in an inductor L and direct that current flow through a diode or transistor to raise a drive voltage +V on a first external capacitor. The ratio between the drive voltage +V and the 12V input voltage is determined by the duty cycle of the switch, enabling the boost module 210 to control the drive voltage by varying the setpoint of the duty cycle. The boost module may use a first duty cycle setpoint with a value near, e.g., 0.95, to provide a drive voltage of 12.5V for diagnostic operations. For cleaning or de-icing operations, the boost module may use a second duty cycle setpoint with a value near, e.g., 0.33, to provide a drive voltage of about 35V. Whatever the drive voltage +V, voltage inverter 212 duplicates the drive voltage to a second external capacitor, changing the sign to provide a negative drive voltage −V.

The multi-state transducer driver 214 has a first switch SW1 that selectively couples a drive terminal of the piezoelectric element PZ to the negative drive voltage −V; a second switch SW2 that selectively couples the drive terminal to ground, and a third switch SW3 that selectively couples the drive terminal to the positive supply voltage +V. If all three switches are open, the drive terminal is held in a high-impedance state. The driver can thus provide four states: a high-impedance state, a positive voltage state, a negative voltage state, and a ground state. Unless otherwise stated, references herein to a low-impedance state herein refer to the ground state.

A receiver 215 includes a buffer amplifier 216 to buffer the drive terminal voltage, attenuating the voltage to avoid exceeding the input range of the ADC. The attenuation is preferably programmable to accommodate the use of higher or lower drive voltages. The ADC senses the drive terminal voltage, which corresponds to the voltage V_{PZ} across the piezoelectric transducer. The buffer 216 and ADC are just one illustrative implementation of a receiver for sensing the transducer voltage. Other digital and analog receiver implementations would also be suitable.

As an alternative to providing control logic using firmware-configured operation of a programmable MCU, the transducer controller 206 may employ application specific integrated circuit (ASIC)-based control logic circuitry with or without programmable parameters to configure the USCD operation.

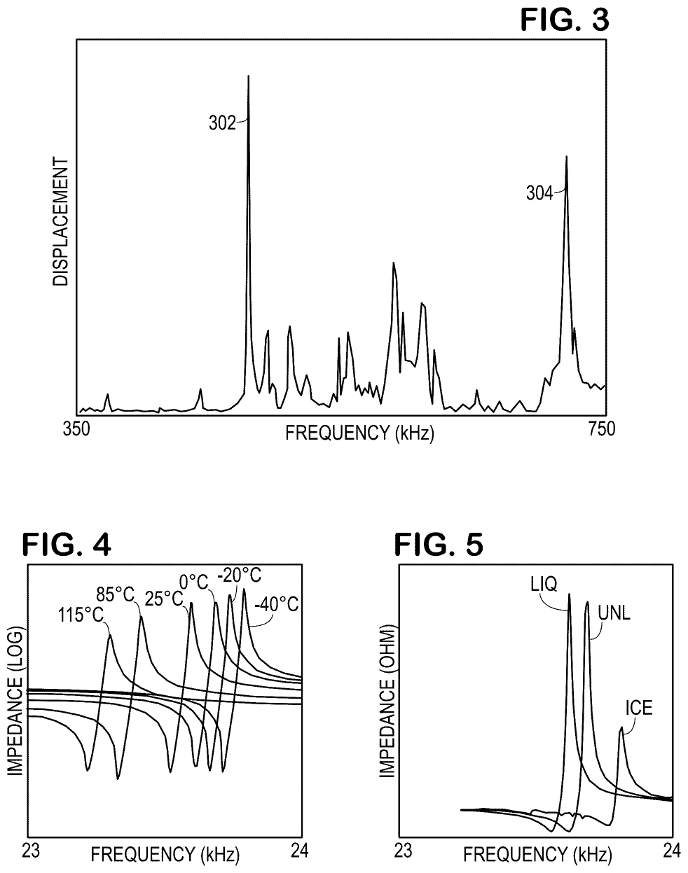

As a prelude to discussing preferred operation of the control logic, it is noted here that existing techniques for resonance frequency tracking during driving of the transducer are in many circumstances inoperative or at best unreliable. The authors believe these issues arise when the transducer as configured for the desired operation exhibits multiple, closely spaced resonance peaks. As one example, FIG. 3 shows a graph of displacement versus frequency for an illustrative USCD-equipped sensor. The graph reveals multiple resonance peaks, including a primary resonance 302 at about 485 kHz and a secondary resonance 304 at about 715 kHz. The secondary resonance, in combination with the cluster of minor resonances in the 490 kHz to 625 kHz range, may prevent existing techniques from adaptively tracking the primary resonance while the transducer is being driven. Yet such tracking remains desirable.

FIG. 4 is a graph showing the impedance of an illustrative piezoelectric transducer having a resonance peak in the 23 kHz to 24 kHz range. At room temperature (25° C.), the peak is nominally at 23.6 kHz, but as revealed in FIG. 4, the peak exhibits significant shifting as a function of temperature, ranging from as high as 23.8 kHz at −40°° C. to as low as 23.3kHz at 115° C. Given that the full-width half maximum peak width is less than 0.06 kHz, these temperature shifts can place a drive signal at the nominal resonance frequency well outside the current resonance frequency peak, thus rendering the USCD largely ineffectively. To maximize performance and power efficiency, the control logic may adapt the frequency of the drive signal during operation to track the resonance frequency peak.

In addition to the temperature dependence, the USCD is expected to have a dependence on the sensor's loading condition. FIG. 5 shows the impedance of an illustrative USCD transducer at 0° C. The nominal resonance frequency peak of a clean, unloaded (UNL) transducer is at 23.69 kHz. When liquid water droplets (LIQ) adhere to the sensor's surface, the transducer's resonance frequency peak shifts to about 23.62 kHz. Conversely, when a thin layer of ice (ICE) adheres to the sensor's surface, the transducer's resonance frequency peak shift increases to 23.81 kHz. The control logic may use this dependency to detect sensor loading. Note that as the adherent substances are atomized or otherwise dispersed, the resonance frequency peak will shift back toward the nominal value. To maximize performance and power efficiency, the control logic may accordingly adapt the frequency of the drive signal during cleaning and de-icing operations to track the resonance frequency peak.

In connection with FIGS. 3-5 it may be noted that the USCD can be designed to provide narrow resonance peaks, i.e., resonances with a high quality factor, e.g., approaching or exceeding Q=900. Such narrow peaks offer efficient conversion of drive energy to yield relatively large surface displacements, which may offer more effective cleaning operations. A consequence, however, is that a close correspondence is desired between the peak frequency and the drive frequency, as the desired displacements can only be achieved over a smaller range of drive frequencies. Accordingly, the control logic may be configured to adapt the drive frequency in real time to track the resonance frequency peak as closely as possible, and those controllers using digital frequency control may be configured to use a small adaptation step size. Suitable step sizes may be 20 Hz or less, more preferably 10 Hz or less, or 5 Hz or less, or optimally approximately 3 Hz or less.

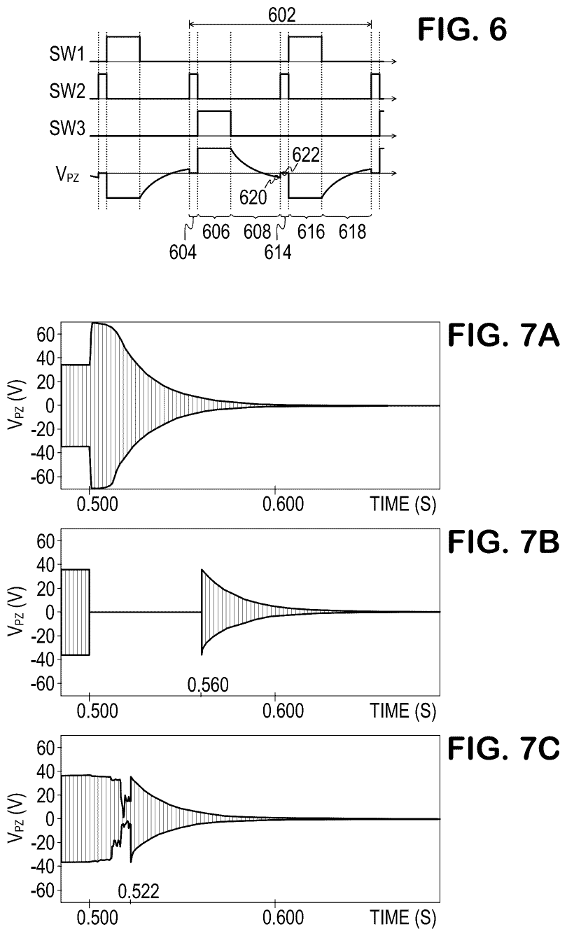

FIG. 6 is a timing diagram illustrating the operation of the multi-state driver 206. The first signal graph is the control signal for switch SW1, which is asserted to selectively couple the drive terminal to the negative drive voltage −V. The second signal graph is the control signal for switch SW2, which is asserted to selectively couple the drive terminal to ground. The third signal graph is the control signal for switch SW3, which is asserted to selectively couple the drive terminal to the positive drive voltage +V. When all three control signals are de-asserted, the drive terminal is decoupled, i.e., the driver is in a high-impedance state.

The fourth signal graph is the drive terminal voltage waveform V_{PZ}. The waveform is periodic. Interval 602 corresponds to one period of the waveform. The illustrated interval includes two low-impedance intervals 604, 614, corresponding the assertion of the SW2 control signal. Intervals 604, 614 are immediately followed by nonzero voltage pulse intervals 606, 616. Interval 606 is a positive voltage pulse, corresponding to assertion of the SW3 control signal. Interval 616 is a negative voltage pulse, corresponding to assertion of the SW1 control signal. The nonzero voltage pulse intervals 606, 616, are immediately followed by high-impedance intervals 608, 618, corresponding to de-assertion of the three switch control signals.

The nonzero voltage pulses initiate expansion and contraction of the piezoelectric element. The element acquires momentum that continues after the nonzero voltage pulses have terminated, causing the transducer voltage to decay. If interval 602 perfectly matches the period of the resonance frequency peak, the piezoelectric element's momentum (and residual voltage of the drive terminal) converges to zero as the low impedance intervals 604, 614 begin. If the interval 602 is too short, the low impedance intervals 604, 614 begin before the drive terminal voltage converges to zero. Conversely, if interval 602 is too long, the drive terminal voltage exhibits a sign change before the low impedance intervals begin. Thus, a measure of the transducer voltage V_{PZ} waveform during the high-impedance interval just before the low impedance intervals enables the control logic to determine whether the period 602 is too long or too short, and thus whether the drive frequency is too low or too high. In practice, there may be some baseline drift over time, so it may be preferred to measure the transducer voltage waveform just before and just after the low impedance interval begins, and to adapt the drive frequency based on the difference between the two measurements.

In FIG. 6, a transducer waveform measurement 620 is acquired near the end of high impedance interval 608, and a second measurement 622 is acquired near the middle of low impedance interval 614. In this example, the control logic may determine a difference voltage Vdiff by subtracting the low impedance voltage measurement 622 from the high impedance voltage measurement. If the sign of the difference voltage Vdiff is positive, the control logic may adjust the drive frequency downward. Conversely, if the sign of the difference voltage is negative, the control logic may adjust the drive frequency upward. Note that measurements 620, 622 are acquired near the end of the positive half of the transducer voltage waveform. If acquired near the end of the negative half of the transducer voltage waveform, the sign of the difference voltage should be reversed, or equivalently, the difference voltage should be calculated by subtracting the high impedance voltage measurement from the low impedance voltage measurement. In accordance with standard adaptive control techniques, multiple difference voltages may be accumulated and/or filtered over multiple cycles of the waveform to determine an adaptation signal indicating whether the drive frequency should be increased or decreased.

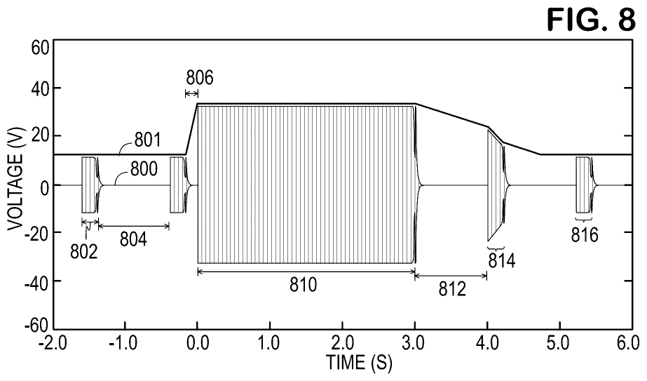

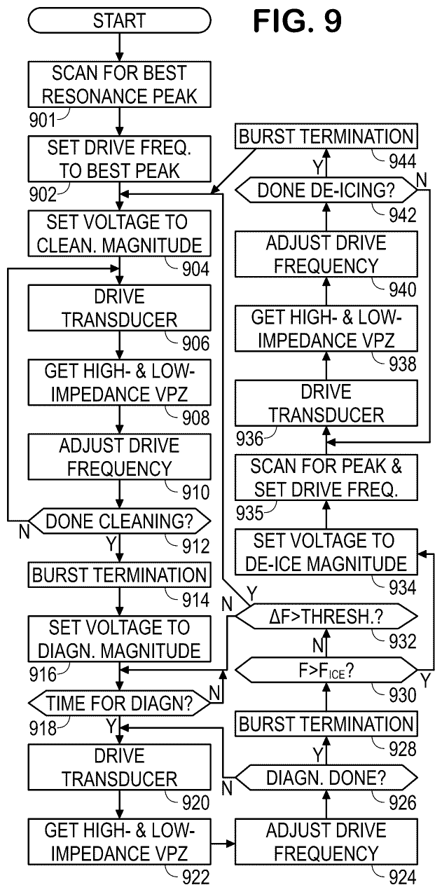

Before discussing the preferred operation of the control logic in connection with FIGS. 8-9, we first discuss the vibration bursts that may be generated by suppling the transducer voltage waveform V_{PZ} to the piezoelectric element's drive terminal. In an initial state, the transducer may be quiescent, with the driver 206 maintained in a high impedance state. When a cleaning operation is desired, the driver may supply nonzero voltage pulses at an initial frequency that is then adapted to match a resonant frequency peak of the transducer to maximize displacement and energy transfer to any substances adhering to the sensor's surface. The transducer vibrates at the drive frequency. When the sequence of nonzero voltage pulses is terminated with, e.g., the driver 206 entering a high-impedance state, the residual vibration of the transducer may generate a sinusoidal voltage signal with a gradual decay envelope.

The initial amplitude of this residual vibration signal may well exceed the magnitude of the nonzero voltage pulses, particularly at a high Q resonance peak, as the transducer gradually dissipates the stored vibration energy. This is the circumstance illustrated in FIG. 7A. Each of FIGS. 7A-7C illustrate the termination of a 0.5 s long waveform with positive and negative 35V pulses at a drive frequency near 23.6 kHz. In FIG. 7A, the driver 206 transitions from the vibration burst waveform immediately to a high-impedance state. The transducer's residual vibration generates a sinusoidal voltage that peaks at approximately 70V before gradually decaying away to near zero at 0.6 s. This voltage peak creates the potential for damage to the driver transistors and/or loss of device longevity due to the voltage stress.

FIG. 7B shows a preferred termination method in which the driver 206 transitions to a ground state at the end of the vibration burst waveform. This ground state may be held until enough of the residual vibration energy has been dissipated to keep the residual vibration signal below the magnitude of the nonzero voltage drive pulses. In this example, the driver 206 maintains the ground state for 0.06 s before transitioning to the high impedance state at 0.56 s. This technique avoids voltage stress on the driver transistors without prolonging vibration of the USDC due to fast energy dissipation levels in the ground state.

FIG. 7C shows an alternative termination method in which, at the end of the 0.5 s vibration burst waveform, the control logic begins reducing the waveform duty cycle in a stepped-linear fashion from about 0.4 to about 0.08 before transitioning to a high impedance state at 0.522 s. The residual vibration signal decays in similar fashion to FIG. 7B, but with prolonged vibration beyond the signal of FIG. 7A. As with FIG. 7B, undue voltage stress on the drive transistors is avoided.

FIG. 8 provides an illustrative transducer waveform 800 to provide an overview of the desired USCD operation. Also shown is a boost voltage 801, reflecting a dynamic supply voltage setpoint for the positive and negative drive voltages. Initially, the boost voltage 801 is set at a default level suited for the nonzero voltage pulses used for diagnostic operations. The illustrated level is at 13V, but larger and smaller voltage levels are expected to be suitable. A preferred default level would offer adequate sensitivity for tracking resonance frequency peaks (and thereby detecting any adherent substances) while minimizing power consumption.

The transducer is initially quiescent with the driver 206 being held in a high impedance state. Periodically, the control logic generates a diagnostic vibration burst and dynamically adapts the drive frequency to match the resonance frequency peak, thereby enabling the control logic to track the resonance frequency peak and any changes thereto. The illustrated burst duration 802 is 200 ms, followed by a 25 ms interval in which the driver 206 transitions to a ground state (termination method 7B) and an appendant residual vibration signal that decays away within 75 ms. FIG. 8 presumes the use of termination method 7B after each diagnostic or cleaning burst. A delay interval 804 is provided after each diagnostic vibration burst. The illustrated delay interval 804 is about 1 s, but may be varied to minimize power consumption while still accounting for the maximum expected rates of change for the resonance frequency peak.

In the present example, it is assumed that the control logic detects with the second diagnostic burst a significant change in the resonance frequency peak, and accordingly initiates a cleaning operation. The cleaning operation begins with a change to the supply voltage setpoint, causing the boost voltage 801 to ramp upward during interval 806. Once a sufficient supply voltage (e.g., 35V) is achieved, the control logic performs a cleaning operation during interval 810.

The illustrated cleaning operation involves a 3.0 s vibration burst waveform using a nonzero pulse magnitude of about 35V. The control logic adapts the drive frequency to track the resonance frequency peak to maximize energy transfer to any adherent substances even as the transducer loading is reduced. The illustrative cleaning burst waveform may include 7B termination cycle, and may be followed by a residual vibration decay signal lasting less than 100 ms. At the end of the cleaning burst waveform, the control logic may return the supply voltage setpoint to the default value, enabling the boost voltage 801 to gradually drop back to its default level. After a driver cool-down interval 812, shown here as about 1 s, the control logic returns to generating periodic diagnostic bursts 814, 816. Diagnostic burst 814 is shown as being transmitted before the boost voltage 801 has fully returned to its default level, resulting in the use of an elevated diagnostic pulse magnitude, but the control logic functions as before to track any variation of the resonance frequency peak.

FIG. 9 is a flow diagram of an illustrative method that may be implemented by the control logic to implement USCD functionality in a suitably equipped sensor. The method begins in block 901 with power-on or reset triggering a scan of a predetermined frequency range (selected to cover all expected operating conditions) to identify a strong resonance peak. The scan may be “fast”, i.e., employing a relatively large step size to enable a high amplitude resonance peak to be quickly identified. Where multiple peaks are identified, the one with the largest amplitude may be chosen. Contemplated step sizes include 25Hz, 35 Hz, 50 Hz, 100 Hz. In some implementations, the control logic employs an adaptive step size or recursive search to more narrowly search near previously identified peak values. In block 902 the control logic sets the initial drive frequency to correspond with one of the resonance peaks.

In block 904, the control logic adjusts a supply voltage setpoint to prepare for a cleaning burst. For example, the supply voltage setpoint may be set to 35V to provide a cleaning burst waveform with nonzero voltage pulses having a magnitude of about 35V. Once the desired supply voltage is reached, the control logic in block 906 begins supplying the cleaning burst waveform to the transducer. Note that in some implementations the control logic may provide pulse shaping with gradually transitions (rather than the sharp transitions shown in FIG. 6) to minimize emissions of potential electromagnetic interference (EMI) energy. In block 908, the control logic obtains a transducer voltage measurement during a high impedance interval of the waveform and preferably also obtains a transducer voltage measurement during an associated low impedance interval of the waveform. In block 910, the control logic adapts the drive frequency of the cleaning burst waveform. As discussed previously, the frequency may be adapted based on the high impedance voltage measurement or based on the difference between the high impedance and low impedance voltage measurements. This adaptation enables fine-tuning of the drive frequency to better match the resonance peak frequency.

In block 912, the control logic determines whether the cleaning burst should be terminated. Various criteria may be used for this determination. For example, the control logic may employ a timer or cycle counter to limit the cleaning burst to a fixed duration. Alternatively, the control logic may determine whether the resonance frequency has converged to a stable or predetermined value that indicates a clean, dry transducer surface free of adherent substances. The control logic loops through blocks 906-912 until a burst termination is needed. As the rate of convergence to the resonance peak is expected to be much faster than any frequency drift in that resonance peak, blocks 908 and 910 need not be performed for each drive pulse in a given burst, but rather may be performed intermittently, e.g., during one out of each of a predefined number of pulses.

One the control logic decides to terminate the cleaning burst, in block 914 the control logic may terminate the burst as described previously in connection with FIG. 7B or 7C. Once the burst termination is complete, the control logic stops driving the transducer (e.g., setting the driver in a high impedance state) and sets the supply voltage setpoint to a default value suitable for diagnostic bursts in block 916. For example, the supply voltage setpoint may be set to 13V to provide a diagnostic burst waveform with nonzero voltage pulses having a magnitude of about 12V.

In block 918, the control logic holds the driver in the high impedance state until sufficient time has passed before the sending of a diagnostic burst. Once sufficient time has passed, the control logic in block 920 begins supplying a diagnostic burst waveform to the transducer. As previously noted, some implementations of the control logic may provide pulse shaping to minimize EMI emissions. In block 922, the control logic obtains a transducer voltage measurement during a high impedance interval of the waveform and preferably also obtains a transducer voltage measurement during an associated low impedance interval of the waveform. In block 924, the control logic adapts the drive frequency of the diagnostic burst waveform. In block 926, the control logic determines whether the diagnostic burst should be terminated. For example, the control logic may employ a timer or cycle counter to limit the diagnostic burst to a fixed duration. The control logic loops through blocks 920-926 until a burst termination is needed. In some implementations, blocks 922 and 924 are performed intermittently.

One the control logic decides to terminate the diagnostic burst, in block 928 the control logic may terminate the burst using a previously described termination method such as those of FIG. 7B or 7C. Once the termination is complete, the control logic stops driving the transducer (e.g., setting the driver in a high impedance state).

In block 930, the control logic evaluates the current value of the drive frequency, comparing it to a predetermined threshold value f_{ICE} that indicates the presence of ice on the exposed surface of the transducer. If the drive frequency does not exceed the threshold, then in block 932 the control logic determines whether the present value of the drive frequency has changed by more than a threshold amount relative to a previous drive frequency value. The previous drive frequency value may be, e.g., the adapted frequency at the end of the most recent cleaning burst. Alternatively, the previous value may be the drive frequency at the end of a preceding burst, whether diagnostic or cleaning. If the change does not exceed the threshold, the control logic returns to block 918. If the change does exceed the threshold, the control logic returns to block 904 for a cleaning operation.

Returning to block 930, if the drive frequency exceed the f_{ICE} threshold value, the control logic transitions to block 934, adjusting the supply voltage setpoint to prepare for a de-icing burst. For example, the supply voltage setpoint may be set to 35V to provide a de-icing burst waveform with nonzero voltage pulses having a magnitude of about 35V. In some implementations, the supply voltage may be higher, and the burst duration may be longer, for de-icing operations than for cleaning operations. Once the desired supply voltage is reached, the control logic in block 935 may perform a fast scan to identify resonance peaks in a predetermined frequency range suited for de-icing operations. The control logic sets the drive frequency to correspond to the resonance peak. If multiple peaks are identified, the control logic may select the peak with the largest amplitude. The control logic in block 936 begins supplying the de-icing burst waveform to the transducer. In block 938, the control logic obtains a transducer voltage measurement during a high impedance interval of the waveform and preferably also obtains a transducer voltage measurement during an associated low impedance interval of the waveform. In block 940, the control logic adapts the drive frequency of the de-icing burst waveform.

In block 942, the control logic determines whether the de-icing burst should be terminated. Various criteria may be used for this determination. For example, the control logic may employ a timer or cycle counter to limit the de-icing burst to a fixed duration. Alternatively, the control logic may determine whether the resonance frequency has converged to a stable or predetermined value that indicates a clean, dry transducer surface free of adherent substances. The control logic loops through blocks 936-942 until a burst termination is needed. In some implementations, blocks 938 and 940 may be performed intermittently to increase efficiency.

One the control logic decides to terminate the de-icing burst, in block 944 the control logic may terminate the burst employing a suitable termination method such at those described in connection with FIGS. 7B and 7C. Once the burst termination is complete, the control logic stops driving the transducer (e.g., setting the driver in a high impedance state) and returns to block 904.

Though FIG. 9 shows the described operations in a sequential order for explanatory purposes, the operations may in practice be re-ordered and/or performed concurrently. While the foregoing disclosure has focused on automotive applications, the principles described herein may be applied to other contexts where sensor surface or lens cleaning is required, such as security cameras, industrial inspection systems, or medical imaging devices.

What is claimed is:

1. A controller that comprises:
a driver configured to drive a transducer with a periodic waveform having voltage pulses and a high impedance intervals repeating at a drive frequency;
a receiver configured to measure a high impedance voltage of the transducer during the high impedance intervals; and
control logic configured to adjust the drive frequency using the high impedance voltage to track a resonance frequency of the transducer.

2. The controller of claim 1, wherein the voltage pulses include zero voltage pulses and nonzero voltage pulses, wherein the receiver is configured to measure a low impedance voltage of the transducer during the zero voltage pulses, and wherein the control logic determines based on a sign of a difference voltage between the high impedance voltage and the low impedance voltage whether the resonance frequency is greater or less than the drive frequency.

3. The controller of claim 2, wherein the control logic is configured to adjust the drive frequency with a step size of no more than 20 Hz.

4. The controller of claim 2, wherein the resonance frequency is a center frequency of a high-Q peak that is dependent on adherent substance loading of a lens surface vibrationally coupled to the transducer.

5. The controller of claim 2, wherein the control logic is configured to find the resonance frequency on start up or reset by scanning a predetermined frequency range to find a resonance peak and performing an initial cleaning operation to fine tune the drive frequency.

6. The controller of claim 5, wherein the control logic is configured to perform periodic diagnostic operations to monitor the resonance frequency.

7. The controller of claim 6, wherein the control logic is configured to perform a de-icing operation if the resonance frequency exceeds a predetermined threshold.

8. The controller of claim 6, wherein the control logic is configured to perform a cleaning operation if the resonance frequency changes by more than a predetermined amount between diagnostic operations.

9. The controller of claim 6, wherein the diagnostic operations have nonzero voltage pulses of a reduced magnitude relative to a magnitude of nonzero voltage pulses for a cleaning operation.

10. A method that comprises:
driving a transducer with a periodic waveform having voltage pulses and a high impedance intervals repeating at a drive frequency, the transducer being configured to impart ultrasonic vibrations to a lens surface;
determining based on a high impedance voltage of the transducer during the high impedance intervals whether a resonance frequency of the transducer is greater or less than the drive frequency; and
adjusting the drive frequency during said driving to track the resonance frequency.

11. The method of claim 10, wherein the voltage pulses include zero voltage pulses and nonzero voltage pulses, wherein the method further comprises:
measuring a low impedance voltage of the transducer during the zero voltage pulses, and
wherein said determining whether the resonance frequency of the transducer is greater or less than the drive frequency is based on a sign of a difference voltage between the high impedance voltage and the low impedance voltage.

12. The method of claim 11, further comprising finding the resonance frequency on start up or reset by scanning a predetermined frequency range to find a resonance peak and performing an initial cleaning operation to fine tune the drive frequency.

13. The method of claim 11, further comprising:
performing periodic diagnostic operations to monitor the resonance frequency;
performing a de-icing operation if the resonance frequency exceeds a predetermined threshold; and
performing a cleaning operation if the resonance frequency changes by more than a predetermined amount between diagnostic operations.

14. The method of claim 13, wherein the diagnostic operations have nonzero voltage pulses of a reduced magnitude relative to a magnitude of nonzero voltage pulses for the cleaning operation.

15. A sensor that comprises:
a lens surface configured for exposure to adherent substances;
a transducer configured to impart ultrasonic vibrations to the lens surface; and
a controller configured to perform a cleaning operation by:
driving the transducer with a periodic waveform having voltage pulses and a high impedance intervals repeating at a drive frequency,
determining based on a high impedance voltage of the transducer during the high impedance intervals whether a resonance frequency of the transducer is greater or less than the drive frequency; and
adjusting the drive frequency during said driving to track the resonance frequency.

16. The sensor of claim 15, wherein the voltage pulses include zero voltage pulses and nonzero voltage pulses, wherein the controller is configured to measure a low impedance voltage of the transducer during the zero voltage pulses, and wherein the controller determines based on a sign of a difference voltage between the high impedance voltage and the low impedance voltage whether the resonance frequency is greater or less than the drive frequency.

17. The sensor of claim 16, wherein the controller is configured to optimize operations by:
finding the resonance frequency on start up or reset, said finding including:
scanning a predetermined frequency range to find a resonance peak; and
performing an initial cleaning operation to fine tune the drive frequency;
performing periodic diagnostic operations to monitor the resonance frequency;
performing a de-icing operation if the resonance frequency exceeds a predetermined threshold; and
performing the cleaning operation if the resonance frequency changes by more than a predetermined amount between diagnostic operations.

18. The sensor of claim 17, wherein the diagnostic operations have nonzero voltage pulses of a reduced magnitude relative to a magnitude of nonzero voltage pulses for the cleaning operation.

19. The sensor of claim 15, wherein the controller is configured to perform said adjusting the drive frequency using a step size of no more than 20 Hz.

20. The sensor of claim 15, wherein the resonance frequency is a center frequency of a high-Q peak that is dependent on adherent substance loading of the lens surface.
